(19) United States
(12) Patent Application Publication
(10) Pub. No.: US 2005/0125677 A1
(43) Pub. Date: Jun. 9, 2005

(54) Generic token-based authentication system

(76) Inventor: Phyllis J. Michaelides, Warwick, RI (US)

Correspondence Address: HOWREY SIMON ARNOLD & WHITE LLP, c/o IP DOCKETING DEPARTMENT, 2941 FAIRVIEW PARK DRIVE, SUITE 200, FALLS CHURCH, VA, 22042-7195, US

(21) Appl. No.: 10/731,629

(22) Filed: Dec. 9, 2003

(51) Int. Cl. H04K 1/00; H04L 9/00

(52) U.S. Cl. 713/185

(57) ABSTRACT

To integrate a target application with an authentication system, a system administrator uses a graphical user interface to select configuration options from a series pages to define a user login process for the target application. An authentication module is created for the target application, and the configuration information is stored in a database. When a user attempts to login to the target application, the login request is redirected to a server containing the authentication module and the authentication module is activated to retrieve the configuration information from the database to conduct the login process. The authentication system is used for authenticating the user and then a token is issued for enabling the user to access the target application.

### LIMITED COPYRIGHT WAIVER

A portion of the disclosure of this patent document contains computer display screen templates to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever.

### TECHNICAL FIELD

The present invention relates generally to authentication of users in a data network, and more particularly to the integration of diverse applications to a centralized authentication system.

### BACKGROUND ART

Over the years, commercial enterprises have used a wide variety of network applications. More recently, it has been desired to use these diverse applications in a secure fashion in such a way that users can use the same user names and passwords for logins to the diverse applications. To avoid synchronization problems, multiple network applications have shared a centralized directory of user name and password information. Standardized protocols have been adopted for access to the centralized directory. These standardized protocols include the Lightweight Directory Access Protocol (LDAP), and the Windows Active Directory (AD).

Once the central directory has been accessed, and information in the directory has been used to authenticate the user, and to verify that the user is authorized for a particular network application, the user can be given one or more tokens to access one or more servers in the network in accordance with a standard security protocol. Standard security protocols include Secure Socket Layer (SSL) and Kerberos.

Problems have arisen with the sharing of a centralized authentication database when it is desired to integrate legacy applications with current protocols such as LDAP and AP, or where it is desired for an application using an operating system such as UNIX or Linux to be integrated with a protocol such as AP originally designed for a substantially different operating system such as Windows. Software vendors have attempted to address these problems by providing command line utilities and access to operating system shell programming and login scripts. However, such customization to fit specialized user authentication requirements requires a good deal of effort by a highly skilled software engineer.

### SUMMARY OF THE INVENTION

In accordance with one aspect, the invention provides a generic system for integrating a target application to an authentication system for authenticating users of the target application. The generic system includes a server coupled to a database of configuration information about a login process for the target application. The server is programmed to access the database of configuration information to conduct the login process with a user of the target application and to use the authentication system to authenticate the user and to enable the user to access the target application once the authentication system has authenticated the user. The generic system further includes an administrative application for permitting a system administrator to create and edit the configuration information.

In accordance with another aspect, the invention provides a generic token-based system for integrating a target application on a first server to an authentication system for authenticating users of the target application. The generic system includes a second server coupled to a database of configuration information about a login process for the target application. The second server is programmed to access the database of configuration information to conduct the login process with a user of the target application and to use the authentication system to authenticate the user and to issue at least one token to enable the user to access the target application once the authentication system authenticates the user. Moreover, the second server is programmed to receive a Uniform Resource Locator including an identification of the target application, and the second server is further programmed to use the identification of the target application for looking up the configuration information for the login process from the database.

In accordance with yet another aspect, the invention provides a method of integrating a target application to an authentication system for authenticating users of the target application. The method includes a system administrator operating a graphical user interface to enter configuration information about a user login process into a database. The graphical user interface presents a series of pages of configuration options to the system administrator. Once the configuration information has been entered into the database, the user login process is conducted with a user of the target application by accessing the configuration information in the database and using the authentication system to authenticate the user and to enable the user to access the target application once the authentication system has authenticated the user.

In accordance with still another aspect, the invention provides a method of using an authentication system for authenticating users of a target application on a first server. The method includes maintaining a database of configuration information about a login process for the target application, and using a second server to access the database of configuration information to conduct the login process with a user of the target application and to use the authentication system to authenticate the user and to issue at least one token to enable the user to access the target application once the authentication system has authenticated the user. A data network couples the first server to the second server, and the second server receives a Uniform Resource Locator including an identification of the target application and uses the identification of the target application for looking up the configuration information for the login process from the database.

In accordance with a final aspect, the invention provides a method of integrating a third-party web application to a centralized authentication system. The method includes a system administrator using a graphical user interface to select configuration options from a series pages to define the login process to be used when a user logs into the third-party web application, creating an authentication module for the third-party web application, storing the configuration information in a database, and redirecting a user login request from the third-party web application to a server containing the authentication module. Upon receipt of the user login request, the server activates the authentication module to retrieve the configuration information from the database to conduct the login process and to use the authentication system for user authentication and then issuing a token for enabling user access to the third-party web application.

### BRIEF DESCRIPTION OF THE DRAWINGS

Other objects and advantages of the invention will become apparent upon reading the following detailed description in view of the drawings, in which:

FIG. 1 is a block diagram showing a generic token-based authentication system being used to integrate a web application to a centralized authentication system;

FIG. 2 is a flow diagram showing how a request from a system administrator is processed in the administrative application and business layer logic introduced in FIG. 1;

FIG. 3 is a first sheet of a flow chart of user authentication in the network of FIG. 1;

FIG. 4 is a second sheet of the flow chart begun in FIG. 3;

FIG. 5 shows a home screen of a graphical user interface (GUI) that the administrative application presents to a system administrator;

FIG. 6 shows an application manager screen of the GUI;

FIG. 7 shows a user interface manager screen of the GUI for defining a language setting;

FIG. 8 shows a user interface manager screen of the GUI for setting respective Uniform Resource Locators (URLs) for a number of language settings;

FIG. 9 shows an inbound parameter manager screen of the GUI;

FIG. 10 shows an outbound parameter manager screen of the GUI;

FIG. 11 shows a toke n manager screen of the GUI;

FIG. 12 shows a LDAP authorization manager screen of the GUI;

FIG. 13 shows a cryptography manager screen of the GUI; and

FIG. 14 shows an import/export manager screen of the GUI.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DESCRIPTION OF THE PREFERRED EMBODIMENT

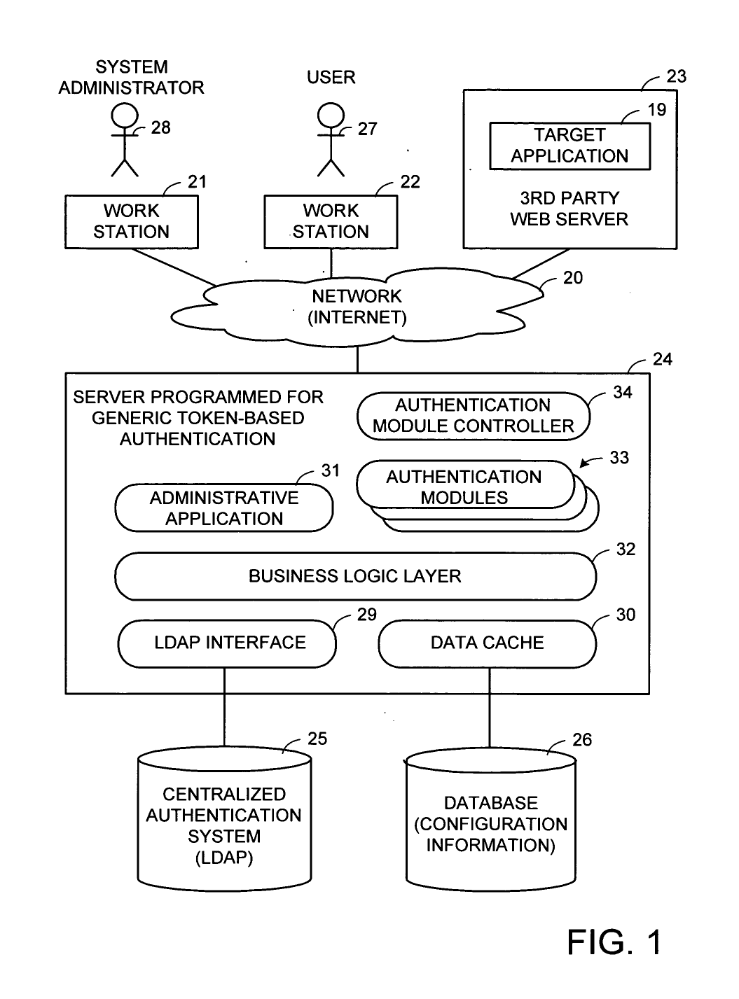

With reference to FIG. 1, there is shown a data network 20 interconnecting a number of work stations 21, 22 to a third-party web server 23 and a server 24 programmed for generic token-based authentication. The server 24 accesses a centralized authentication system 25 such as LDAP in order to verify the user ID and password of a user 27 at the workstation 22 attempting to log into the third-party web server 23 in order to access a target application 19.

The use of third-party web applications is a growing trend. In the past, a business organization would obtain software for an application from an outside vendor and install the software on a secure network under the control of the business organization. Applications that are accessed and used within the confines of a corporate Intranet are considered to be within a “circle of trust”. Most enterprise applications are usually contained within a business organization's secure network. However, more and more organizations are purchasing applications from vendors that supply their own hosting facilities and are by definition outside of the “circle of trust”. The usual method of accessing these applications is simply to logon to the outside vendor's site 23. This may be shortsighted, however, since there are security and privacy issues with that method.

Currently an increasing number of business organizations use applications that are installed on a server at the vendor's site and are linked over the Internet or World-Wide Web. In this context, the term “third-party” refers to an entity that is outside of the business organization's “circle of trust.” The business organization would like to use its own centralized authentication system to authenticate its own employees or customers and to pass necessary information and tokens from the authentication system to the third-party web application. The authentication system could also be used in an e-commerce environment in which the user is a computer program instead of a human user.

The generic token-based authentication system in FIG. 1 addresses this problem by establishing a secure link from the site 24 of the business organization to the site 23 of the outside vendor and, in so doing, extends the “circle of trust” of the business organization to that outside vendor. It enables a corporation's own authentication system 25 to be used instead of an authentication system provided by the outside vendor.

For example, at the time of signing a contract with the outside vendor, a corporation arrives at an understanding that the vendor will not allow anyone from the corporation to be allowed into the vendor's application 19 without receiving a secure token from the corporation. When a user 27 such as an employee of the corporation, for instance, accesses the vendor's site 23, the vendor's site redirects the employee back to the corporate site 24 for verification. Authentication takes place and a token (and other information if needed) is sent securely and encrypted to the vendor's site 23 and the application 19 is now available to the employee. The vendor can also, then, receive information of importance from the corporate authentication system 25.

One great benefit to the vendor is that the responsibility for authentication lies with the corporation and the corporation has greater control over the security and privacy of its information housed at the vendor site 23. In short, the generic token-based authentication system of FIG. 1 extends in a simplified and re-usable manner the “circle of trust” from a corporate Intranet to the Internet or World-Wide Web.

The server 24 integrates the target application 19 of the third-party web server 23 to the centralized authentication system 25 by accessing a database 26 of configuration information for adapting the authentication process of the third-party web server 23 to the centralized authentication system. A system administrator 28 at the workstation 21 manages this configuration information.

The server 24 has an LDAP interface 29 to the centralized authentication system 25 and a data cache 30 interfaced to the database 26. The data cache implements a read-mostly model. The server 24 has an administrative application 31 used by the system administrator for creating and editing the configuration information in the database 26. Specific methods for creating and editing this configuration information are programmed in a layer of business logic 32.

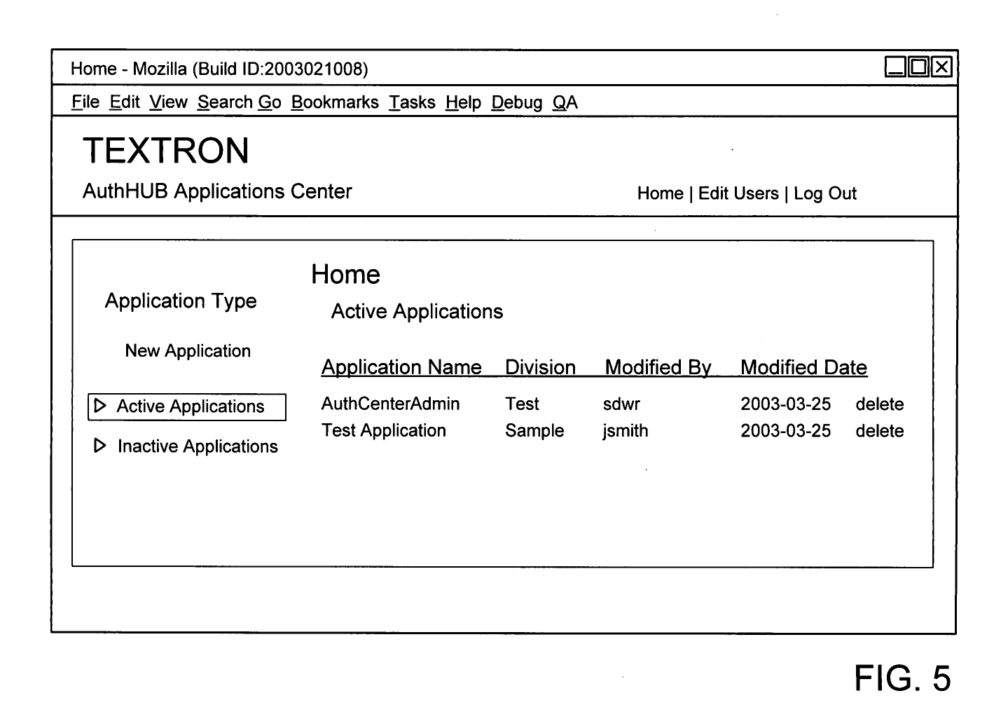

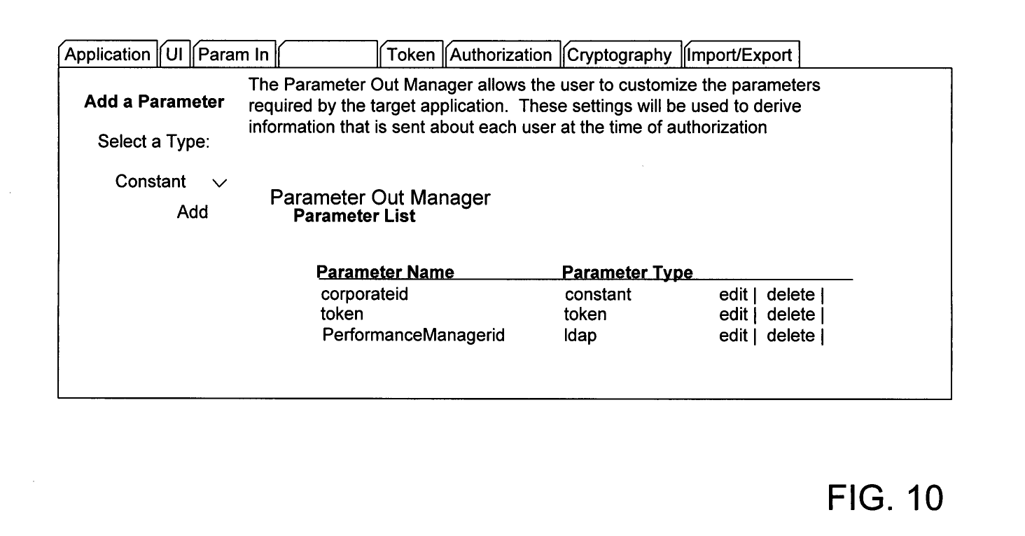

The administrative application 31 also enables the system administrator to create, configure, modify, and delete authentication modules 33. The authentication modules 33 are the elements of the system that do the work of authenticating users as well as passing the authentication tokens to the third-party web server 23. Configuring the modules 33 includes setting message text, adding languages for communication, and setting up cryptography, as will be further described below with reference to FIGS. 5-13. Each authentication module's configuration settings are stored in the database 26 as XML, but for performance reasons, are exposed using an object view in the data cache 30.

The data cache 30 is read-only with respect to the authentication modules. Only the administration application 31 has authority to call read-write methods on the cache objects, and when those methods are called, the cache is invalidated, to assure that the authentication modules 33 pick up the changes correctly.

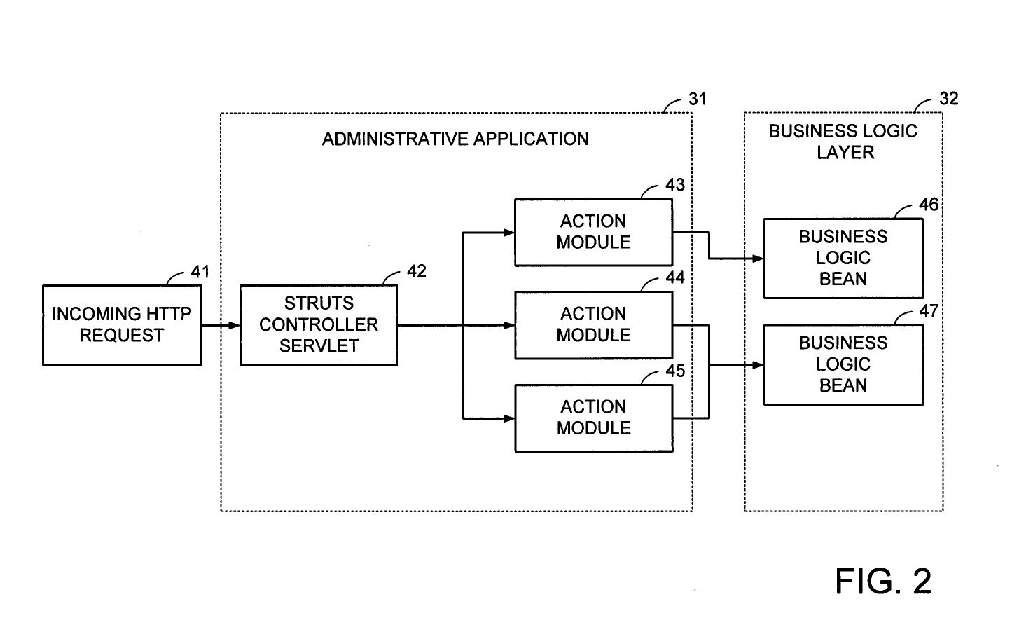

FIG. 2 shows the processing of an incoming hypertext transfer protocol (HTTP) request 41 from the system administrator through the administrative application 31. All of the configuration for the system is done in the administrative application 31. The administrative application uses a Struts 1.1 controller servlet 42 to decode the HTTP requests into requests for various actions performed by respective action modules 43, 44, 45. The action modules validate input and call business logic methods on business logic session beans 46, 47 in the business logic layer 32. In general, the business logic session beans 46, 47 should not be aware that they are being called from HTTP in order to allow for other types of administrative applications.

The Business Logic layer provides all of the business logic for managing the authentication modules. The layer is comprised of a mix of plain JavaBeans and Stateless Session Beans. The primary purpose of the stateless session beans is to interact with the server and database components, as well as to provide the data cache functionality. The JavaBeans are responsible for encapsulating business logic, for functions such as assembling new authentication module components and making changes to existing components.

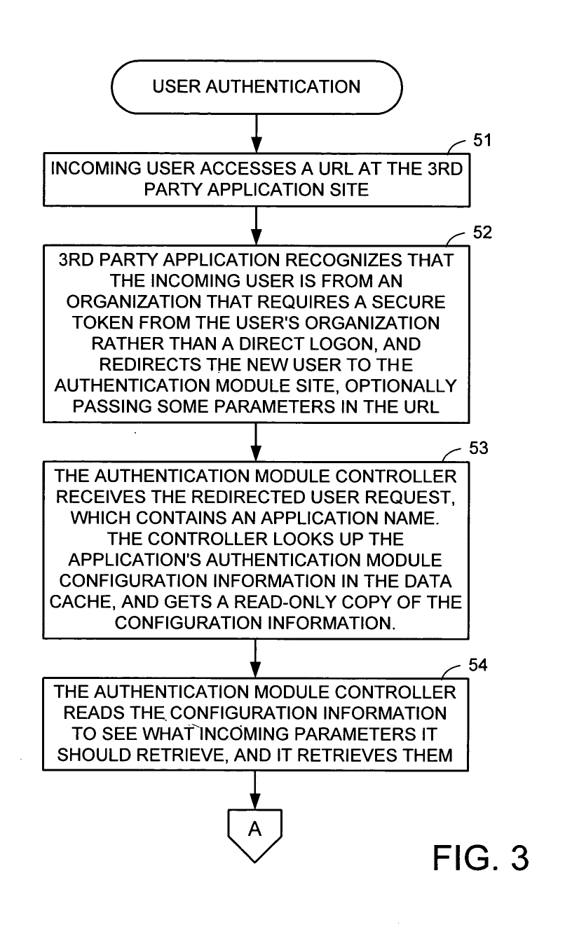

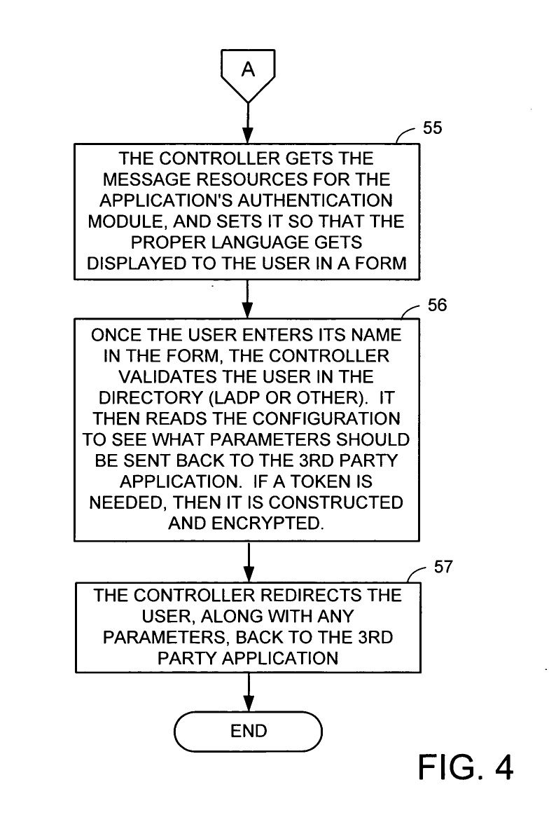

FIGS. 3 and 4 show the method of user authentication in the network of FIG. 1. In a first step 51, an incoming user (i.e., a user not logged into the third-party application site) accesses a URL at the third-party application site. In step 52, the third-party application recognizes that the user is from an organization that requires a secure token from the user's organization rather than a direct logon, and redirects the incoming user to the authentication module site, optionally passing some parameters in the URL. In step 53, the authentication module controller receives the redirected user request, which contains an application name. The authentication module controller reads the configuration information in the data cache, and gets a read-only copy of the configuration information. In step 54, the authentication module controller reads the configuration information to see what incoming parameters it should retrieve, and it retrieves them. Execution continues from step 54 to step 55 in FIG. 4.

In step 55 of FIG. 4, the controller gets the message resources for the application's authentication module, and sets it so that the proper language gets displayed to the user in a form. In step 56, once the user enters its name in the form, the controller validates the user in the directory (LDAP or other). It then reads the configuration to see what parameters should be sent back to the third-party application. If a token is needed, then it is constructed and encrypted. Finally, in step 57, the controller redirects the user, along with any parameters, back to the third party application.

The administration application 31 has two separate classes of users, Admin and Super-Admin. The Super-Admin class has the ability to view, modify, and delete any authentication module. Admin users have access to only the authentication modules that they create or that belong to their group, depending on the access settings on the module. Admin users are never able to view modules that belong to another group. Super-Admin users also have the ability to add, modify, and delete administration application users. Admin users do not have any access to the administration application user management facilities.

A system administrator (Admin or Super-Admin) accesses the administrative application 31 by operating a web browser program in the system administrator's work station (21 in FIG. 1). The system administrator enters a URL for the administrative application 31 into the web browser program. The web browser program sends an access request to the URL, causing the administrative application 31 to recognize the request as originating from an incoming user, and to invoke a logon action module.

The logon action module causes a login page to be displayed to the system administrator. The system administrator enters his or her user name and password into the login page. The login action module authenticates the user in the directory of the centralized authentication system (25 in FIG. 1) and then checks a user table in the database 26 to determine if the user is authorized to use the administration application and the role (e.g., Admin or Super-Admin) that the user has. On success, execution is forwarded to a home page action module. If a user without administrator privileges attempts to log on, a message is returned indicating that the user is not authorized to access the administrative application.

The Admin and Super-Admin classes access the home page action module. Using the logged-in user's information, the home page action module gathers a list of accessible applications and displays a main page to the system administrator. As shown in FIG. 5, this main page has links to application edit pages (activated by the system administrator clicking on “New Application” or an application name), as well as possible links to admin application management and user management pages (e.g., activated by the user clicking on “Edit Users”), depending on the user's role. Applications are divided into two groups, active and inactive. The system administrator can click “Active Applications” or “Inactive Applications” on the left-hand side of the screen to switch viewing between the active applications and the inactive applications. Clicking on the “delete” link to the right of each listed application will remove the application from the authentication system.

Only the Super-Admin class can access the system administration page, which is controlled by a system administration action module. Here the Super-Admin user can modify application settings and turn the applications on or off.

Only the Super-Admin class can access the user management page, which is controlled by a user admin action module. Here the Super-Admin can add, delete, and modify users of the system. This action module is also responsible for handling add, delete, and modify user actions.

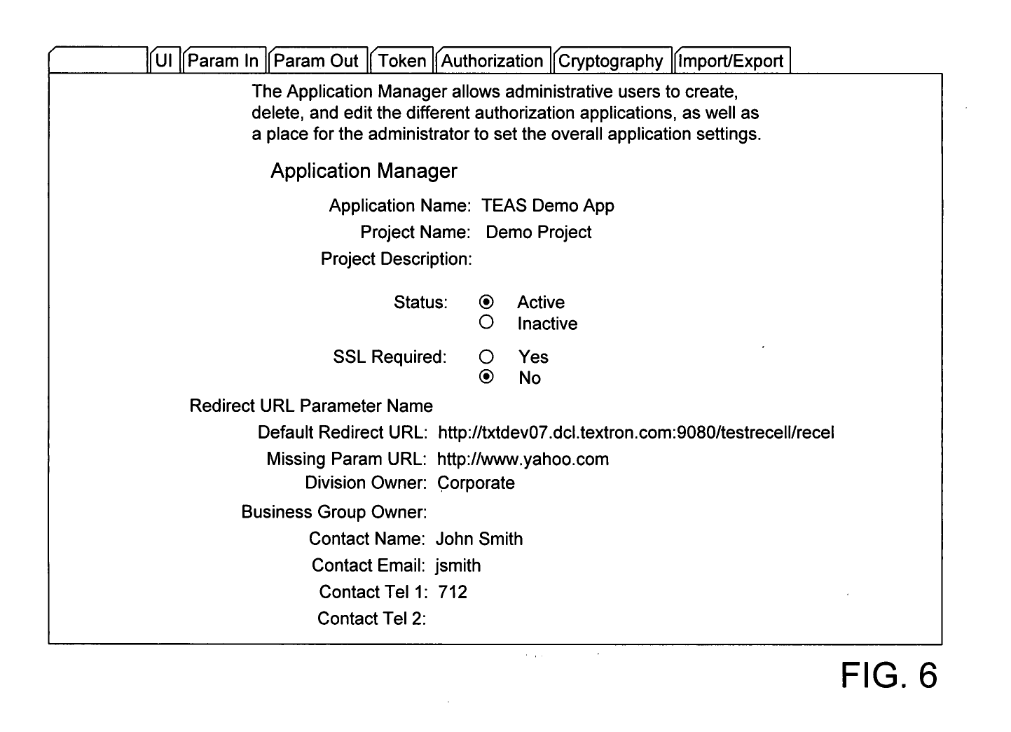

By clicking on an application name on the main page, the Admin and Super-Admin classes access a summary action module that takes the user to an application manager summary page for the selected target application. As shown in FIG. 6, this summary page contains overview information as well as links to various edit pages. These links (UI, param in, param out, token, authorization, cryptography, import/export) appear at the top of the page in FIG. 6.

The application manager summary page in FIG. 6 is used to integrate a new application into the authentication system or to edit an existing application configuration. The system administrator can access a number of fields on this page. The “application name” field contains the name of the selected target application. It is used to create the URL that will allow access to this application. This name should not include any special characters or symbols. The “project name” field may contain the name of a project that the application configuration is for. This field is informational only. The “project description” field may contain a brief description of the application or project. This field is informational only. The “status” field indicates whether the application is active or inactive. If the application is inactive, users attempting to access the application login screen will receive an error message. The “SSL required” field can be used to determine whether or not users must access the selected target application with the https protocol.

The “redirect URL parameter name” should contain the name of a final redirect URL if such a URL is to be passed in as a parameter to the login page. If this field is not filled in, then the “default redirect URL” field must be completed. The default redirect URL is the URL where users will be taken upon a successful login, unless the redirect URL parameter field is populated and the redirect URL parameter is present. The “missing param URL” may contain a URL to which a user is taken if any of the required inbound parameters are missing. If the missing param URL field is empty, then a user is taken back to the login page.

The “division owner” field indicates the division that is responsible for the integration of the selected target application. For admin users, this field is editable. For non-admin users, this field is populated automatically. Users can only see applications that belong to their own division. The “business group owner” field should be used to specify the name of the business group owner. This field is informational only.

The “contact name” should be the name of a person who is responsible for maintaining the selected target application. The “contact email” field should contain the email address of the person listed in contact name. The “contact tel 1” field should contain the telephone number of the person listed in contact name, and the “contact tel 2” should contain an alternate number of the person listed in contact name.

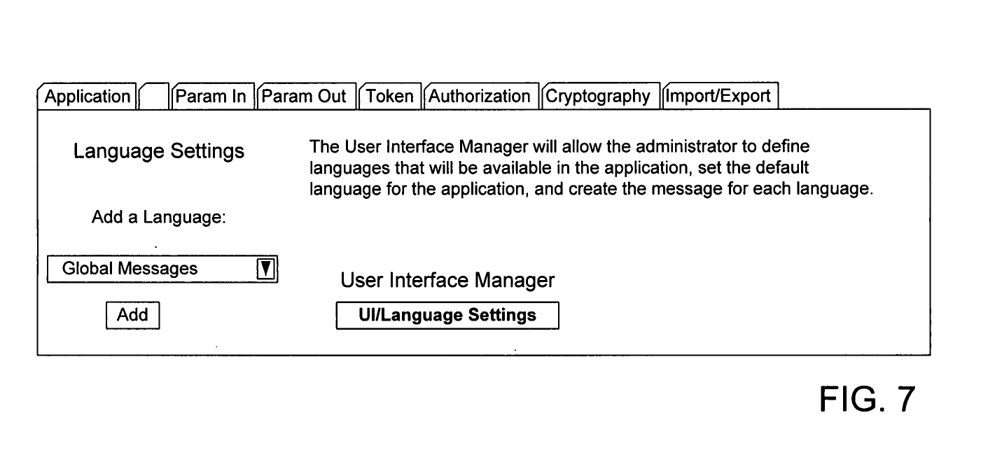

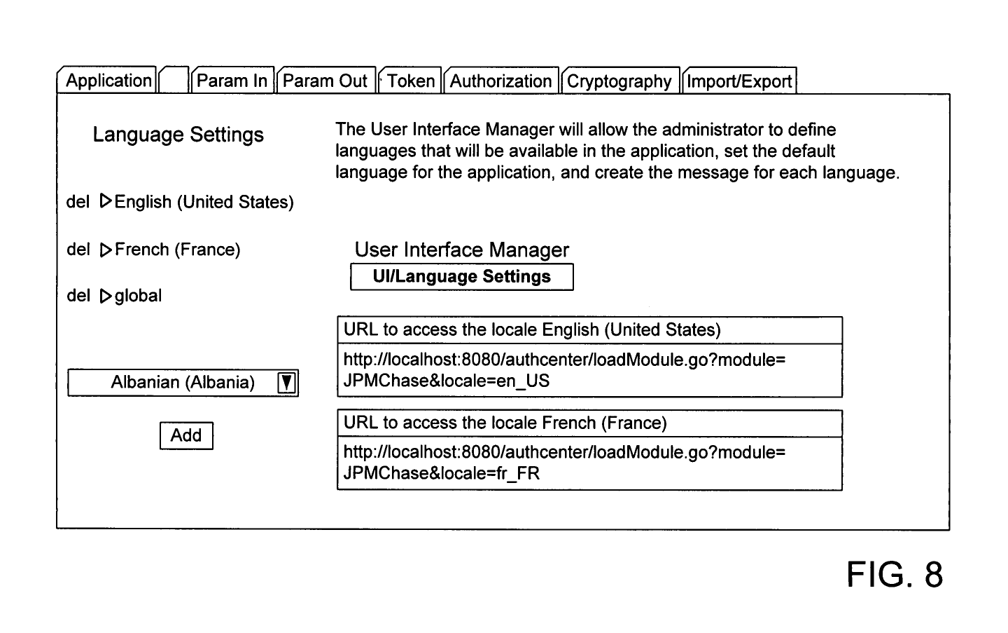

The “UI” link takes the Admin and Super-Admin classes to a series of user interface summary pages for the authentication messages of the selected target application. These pages are shown in FIG. 7 and FIG. 8. A message admin action module controls these pages. The settings on these pages determine the natural languages and messages used for communicating with a user during a user login process. Here the system administrator can add new languages, add messages for existing languages, and set the default language. For a new application, there is a drop-down list with a list of languages that are available for creation. To add a new language (FIG. 7), it is selected from the list, and the “add” button is clicked on. This takes the system administrator to a language edit page.

There is one special language called Global Messages. To display the same text in every language, then that particular message should be filled in the Global Messages language and left blank in the other language configurations. Messages are looked up first in the requested language, and then in the Global Messages language. To delete a language and its associated messages, click the “del” link next to the message name (FIG. 8). To edit a language, click on its name.

When the system administrator first clicks on the UI link, in the right-hand column there is displayed a list of URLs that can be used to access a particular language. These URLs can be selected in order to specify a language to be used. To provide a URL without an explicit language, simply leave off the “locale=XX_xx” portion of the URL. In this case, the user will see whatever language is native to their computer. For example, a user running a French-localized version of Windows will be sent to the French (France) locale if no language is specified.

When the system administrator clicks on the name of an existing language or adds a new language, then the system administrator is taken to a language edit page. This page contains fields for every message that can be displayed to the user in the course of a login. If no message is configured, a blank space will be displayed in its place, unless that particular message is specified in the Global Messages language.

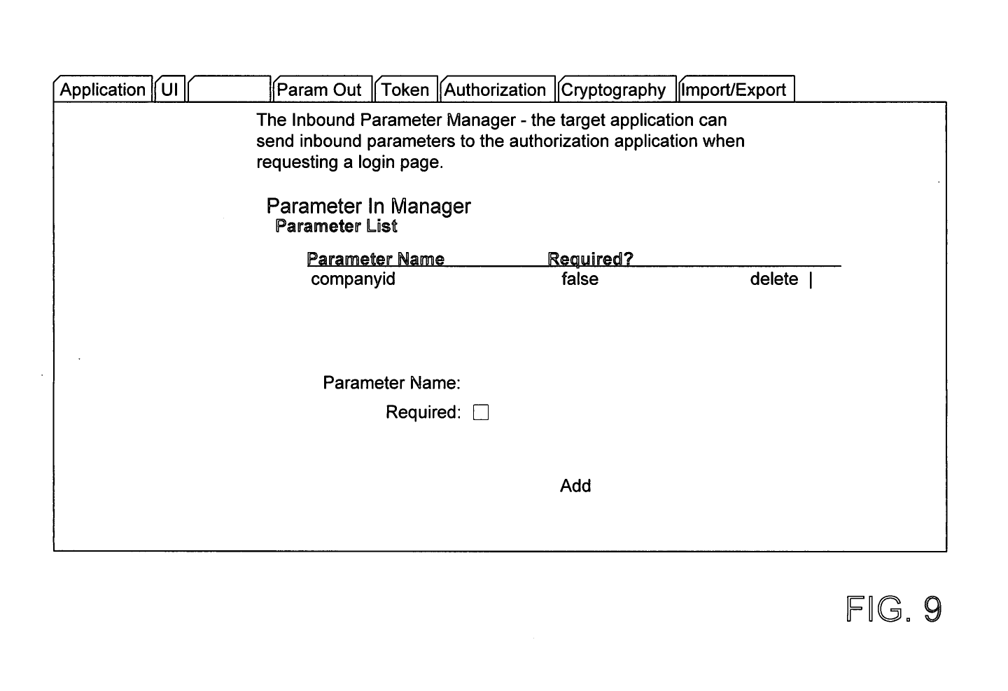

The “param in” link takes the Admin and Super-Admin classes to a summary page for the selected target application's HTTP inbound parameter configuration. An HTTP input parameter admin action module controls this summary page. As shown in FIG. 9, this page allows the system administrator to add, modify, or delete HTTP input parameters that the selected target application sends to the authentication module controller. The list of input parameters defines what parameters should be saved from the login URL. These parameters can later be included in outgoing parameters and/or tokens. To add a new parameter, the system administrator specifies the parameter name and whether or not the parameter is required, and clicks on “add.” If the parameter is marked as required, then if the login URL does not contain that parameter, then the user will be redirected to the URL specified in the “missing param redirect URL” field on the application summary page.

Only inbound parameters specified in the list of input parameters will be saved. All other inbound parameters in the login URL will be ignored. Inbound parameters can be deleted by clicking the delete button. If there are any tokens or outbound parameters that reference the deleted inbound parameter, they will be deleted as well.

The “param out” link takes the Admin and Super-Admin classes to a summary page for the selected target application's HTTP outbound parameter configuration. An HTTP output parameter admin action module controls this summary page. As shown in FIG. 9, this page allows the system administrator to add, modify, or delete outbound parameters that will be sent from the authentication module controller to the selected target application. The left-hand side of the summary page contains a list to select a new type of parameter to add. The right-hand side has a list of the current parameters. Here the system administrator can edit or delete the existing parameters. Outbound parameters are appended to the redirect URL after a successful login. The name of the parameter in the URL is the same as the name in the outbound parameter list. Parameter values are URL-encoded, so they may contain special characters and symbols.

There are several types of outbound parameters that can be defined. A “constant” parameter always returns the specified value. A “timestamp” parameter returns the current date and/or time. The user can specify the formatting, according to the Java SimpleDateFormat class. For example, the formatting string MMddyyyy returns the 2 digit month and day and the 4-digit year. A “LDAP attribute” returns a value from the logged-in user's LDAP profile. If the user is missing the attribute, or it is empty, the parameter will be empty. A list of available attributes is provided. An “inbound parameter” returns the value of an inbound parameter back out in the redirect URL. The inbound parameter must first be configured on the summary page accessed by the “param in” link. A “concatenation” parameter type allows the user to string together multiple parameter values into one. Each sub-parameter is evaluated and the result is concatenated with the others and used as the value. A “token” parameter is an encrypted string containing data defined on the summary page accessed by the “token” link. A “signature” parameter is a signed hash of the token data. This parameter is only available if a token parameter has been configured.

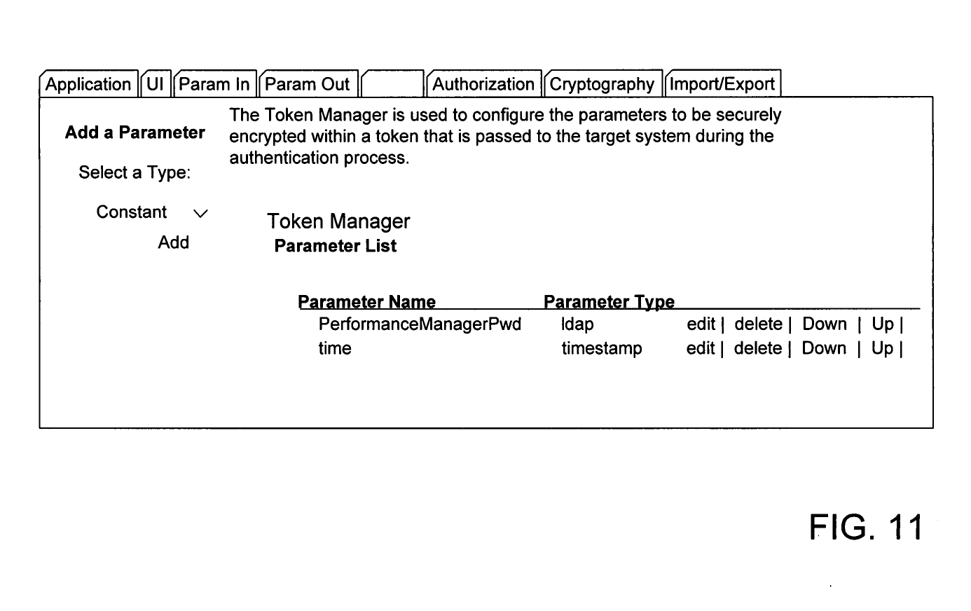

The “token” link takes the Admin and Super-Admin classes to a summary page for the token parameter configuration for the selected target application. A token parameter admin action module controls this summary page. As shown in FIG. 11, this page allows the system administrator to add, modify, or delete token parameters that will be sent to the selected target application.

A token is an encrypted string that can contain multiple values that need to be kept secret from either the user or from any interception. The token summary page behaves almost exactly like the param out summary page, except that the system administrator cannot add a token or signature parameter. The parameters in the token are stored in name=value format, separated by “|” characters. After the data string has been assembled, the data is encrypted using the settings defined on a cryptography summary page accessed by the “cryptography” link.

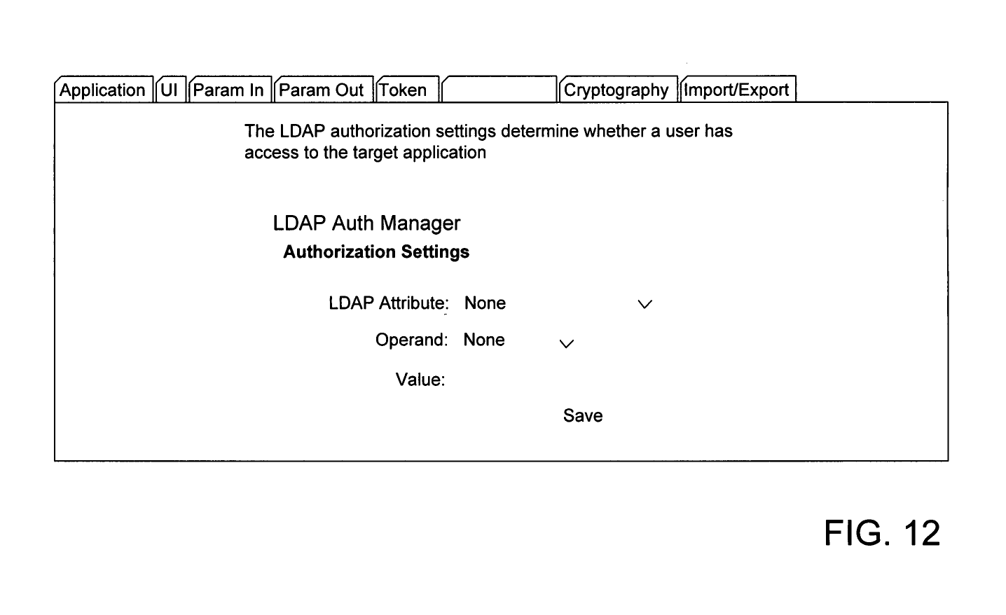

The “authorization” link takes the Admin and Super-Admin classes to a summary page for the authorization settings for the selected target application. An authorization admin action module controls this summary page. As shown in FIG. 12, this page allows the system administrator to add, modify, or delete authorization settings that determine whether a user has access to the selected target application. The system administrator can choose an LDAP attribute, an operand, and a value. The operands available are equals, not equals, starts with and contains. When a user attempts to log in, his or her LDAP profile is checked to see if the criterion is met. If so, the login attempt continues. Otherwise, the user is presented with an error message. If an LDAP attribute has multiple values, they are all checked. All of the operations are also case-insensitive.

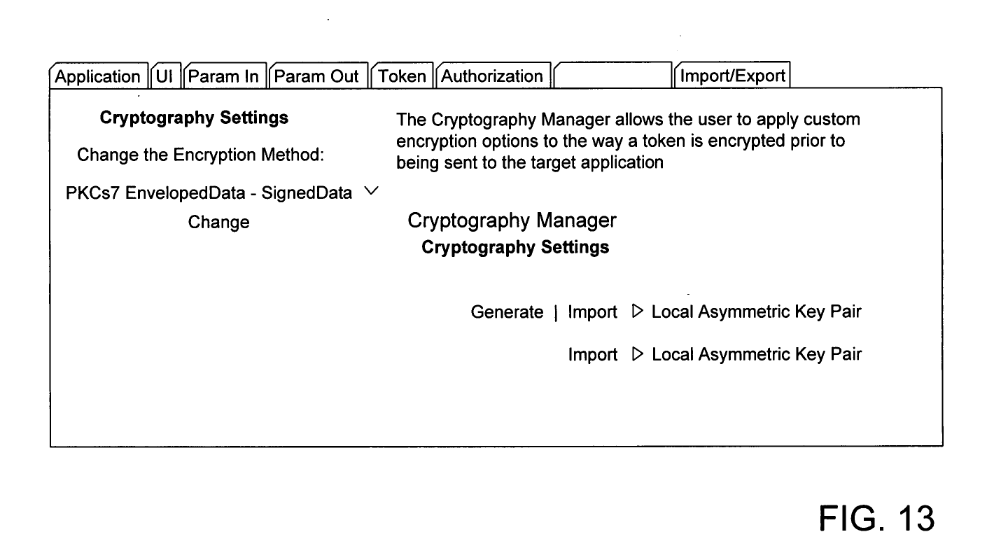

The “cryptography” link takes the Admin and Super-Admin classes to a cryptographic summary page for the selected target application. A cryptography admin action module controls this page. As shown in FIG. 13, this page allows the system administrator to manage the cryptography parameters for the selected target application, including importing, exporting, and generation of keys, and selection of algorithms. For example, the system administrator can select symmetric encryption, asymmetric encryption, and PKCS#7 (symmetric+asymmetric). The desired type of encryption is set in the left hand column. Depending on the type of encryption chosen, one or more of the options in the right hand pane will appear. There are three types of keys needed for the different types of encryption. They each have different import/generate/export options, as described below.

A symmetric encryption key means that both the sender and the receiver must have copies of the same key. This option is only available for symmetric encryption. To generate a symmetric encryption key, the system administrator clicks on the “generate” link, and a pop-up window appears. Clicking the generate button will create a new symmetric key. The system administrator can also import an existing key. In this case, the system administrator also specifies the encryption algorithm and the input format, and then pastes the key into the window. An error message will appear if the import is not successful. For example, keys should be in Base64-encoded format. The system administrator also may export a symmetric key by clicking on the “export” link. Then the system administrator is prompted to choose a file location to save the key to. This key file will be suitable for re-import into another application integrated into the authentication system.

A local asymmetric key pair is an asymmetric public/private key pair. The private key is used for decrypting data, and the public key is used for signing the token. This option is used for the asymmetric and PKCS#7 encryption modes. In this case, when the system administrator clicks on the generate link, the system administrator can then select an encryption algorithm, key size, and signature format. A key pair will then be generated.

In addition, there are two options for importing a local key pair. The first is to import the raw keys. To do this, select the raw key and certificate option in the import window. The next screen will have places for choosing the encryption and signature algorithms and to paste the key values. The second option is to import directly from a Java key store. To do this, the system administrator provides the key store file location, the alias of the public/private key to be imported, and the key store password. The key password must be the same as the key store password.

The system administrator can export its local public key for distribution with the receiving end. The key is exported either as a raw public key (if the key was generated by the authentication system) or as an X.509 certificate (if the key was imported from a key store). The X.509 certificate is much more common, so it is recommended to use the Java keytool application to generate keys and then import them from a key store.

A remote asymmetric public key is the remote user's public key. This is used to encrypt the token data to send to the remote application. This option is used for the Asymmetric and PKCS#7 encryption modes. The system administrator can import the remote public key either from a raw key file or from an X.509 certificate. The system administrator must provide the encryption algorithm. The remote public key can be exported either as a raw key or an X.509 certificate, depending on the form in which it was imported.

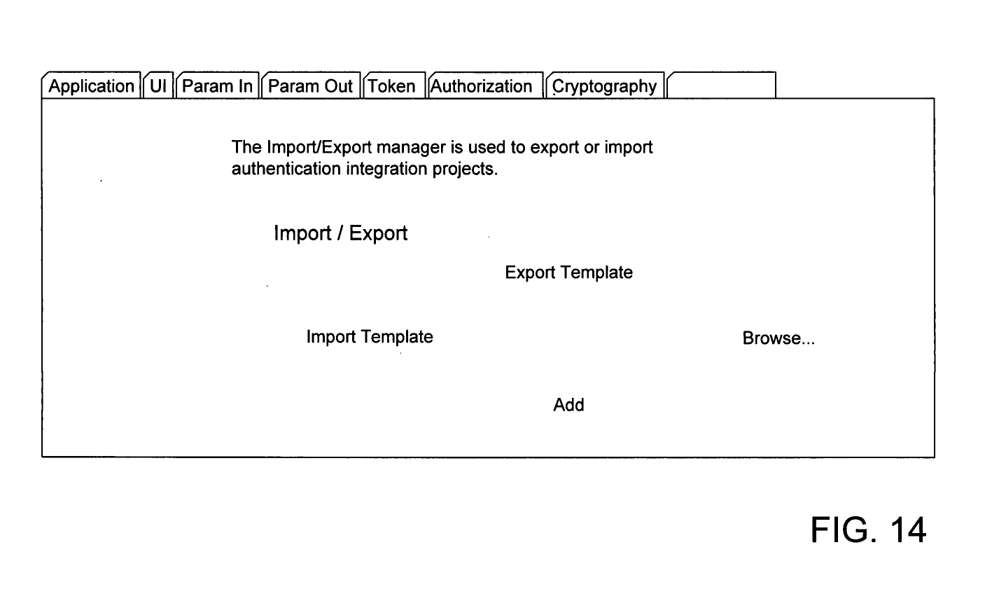

The “Import/Export” link takes the Admin and Super-Admin classes to an import/export summary page for the selected target application. An import/export admin action module controls this page. As shown in FIG. 14, this page allows the system administrator to import or export application profiles. This is useful for keeping backups, transferring applications from staging to production, or for manually manipulating the XML. To export the application, click on the export template. The system administrator is then prompted for a location to save the .xml file. To import a template, click the “browse” button and locate the XML file containing the application and click “add.” The current application will be updated with the data from the XML file, except for the name.

In view of the above, there has been described a generic token-based authentication system and method for integrating third-party web applications to a centralized authentication system. To integrate a third-party web application, a system administrator uses a graphical user interface to select configuration options from a series pages to define the login process to be used when a user logs into the third-party web application. The graphical user interface eliminates the need for programming a customized login script for the third-party web application. The generic system creates an authentication module for the third-party web application and stores the configuration information in a database. When an incoming user attempts to login to the third-party web application, the login request is redirected to the generic system, and the authentication module for the web application is activated and retrieves the configuration information from the database to conduct the login process. The generic system uses the authentication system for authenticating the user and then issues a token for enabling the user to access the third-party web application.

1. A generic system for integrating a target application to an authentication system for authenticating users of the target application, the generic system comprising a server coupled to a database of configuration information about a login process for the target application, the server being programmed to access the database of configuration information to conduct the login process with a user of the target application and to use the authentication system to authenticate the user and to enable the user to access the target application once the authentication system has authenticated the user, the generic system further including an administrative application for permitting a system administrator to create and edit the configuration information.

2. The generic system as claimed in claim 1, wherein the authentication system is a centralized authentication system of a business organization, and the target application is in a third-party web server coupled by a network to the centralized authentication system.

3. The generic system as claimed in claim 1, wherein the server is programmed to issuing at least one token to enable the user to access the target application once the authentication system has authenticated the user.

4. The generic system as claimed in claim 1, wherein a data network couples the target application to the server, the server is programmed to receive a Uniform Resource Locator including an identification of the target application, and the server is further programmed to use the identification of the target application for looking up the configuration information from the database.

5. The generic system as claimed in claim 1, wherein the server is programmed to obtain from the database configuration information defining an inbound parameter, and the server is programmed to receive the inbound parameter from the target application.

6. The generic system as claimed in claim 1, wherein the server is programmed to obtain from the database configuration information defining a natural language, and the server is programmed to use the natural language for communication with the user during the login process.

7. The generic system as claimed in claim 1, wherein the server is programmed to obtain from the database configuration information defining an outbound parameter, and the server is programmed to send the outbound parameter to the target application once the authentication system has authenticated the user.

8. The generic system as claimed in claim 1, wherein the administrative application is programmed to present a graphical user interface to the system administrator for creating and editing the configuration information, and the graphical user interface includes pages for listing active and inactive target applications integrated with the authentication system, and pages for creating and editing a selected one of the target applications.

9. The generic system as claimed in claim 1, wherein the administrative application is programmed to present a graphical user interface to the system administrator for creating and editing the configuration information, and the graphical user interface includes pages for selecting a natural language for conducting the login process, for specifying inbound parameters to be received from the target application and outbound parameters to be sent to the target application, for configuring at least one authorization setting, for configuring at least one token, and for selecting an encryption option for encrypting the token.

10. The generic system as claimed in claim 9, wherein the graphical user interface includes at least one page for exporting and importing authentication integration projects.

11. The generic system as claimed in claim 1, wherein the administrative application is programmed to present a graphical user interface to the system administrator for creating and editing the configuration information, the administrative application includes a series of action modules for presenting respective pages of the graphical user interface to the system administrator, and the action modules are programmed for invoking business logic.

12. The generic system as claimed in claim 1, wherein the server includes a data cache coupled to the database.

13. The generic system as claimed in claim 1, wherein the server is programmed with a plurality of authentication modules for integrating respective target applications to the authentication system, and the server is programmed with an authentication module controller for directing user login requests to the respective authentication modules.

14. A generic token-based system for integrating a target application on a first server to an authentication system for authenticating users of the target application, the generic system comprising a second server coupled to a database of configuration information about a login process for the target application, the second server being programmed to access the database of configuration information to conduct the login process with a user of the target application and to use the authentication system to authenticate the user and to issue at least one token to enable the user to access the target application once the authentication system authenticates the user, wherein the second server is programmed to receive a Uniform Resource Locator including an identification of the target application, and the second server is further programmed to use the identification of the target application for looking up the configuration information for the login process from the database.

15. The generic system as claimed in claim 14, wherein the second server is programmed to obtain from the database configuration information defining an inbound parameter, and the second server is programmed to receive the inbound parameter from the target application.

16. The generic system as claimed in claim 14, wherein the second server is programmed to obtain from the database configuration information defining a natural language, and the second server is programmed to use the natural language for communication with the user during the login process.

17. The generic system as claimed in claim 14, wherein the second server is programmed to obtain from the database configuration information defining an outbound parameter, and the second server is programmed to send the outbound parameter to the target application once the authentication system has authenticated the user.

18. A method of integrating a target application to an authentication system for authenticating users of the target application, the method comprising a system administrator operating a graphical user interface to enter configuration information about a user login process into a database, the graphical user interface presenting a series of pages of configuration options to the system administrator, and once the configuration information has been entered into the database, accessing the configuration information in the database to conduct the user login process with a user of the target application and using the authentication system to authenticate the user and to enable the user to access the target application once the authentication system has authenticated the user.

19. The method as claimed in claim 18, wherein the authentication system is a centralized authentication system of a business organization, and the target application is in a third-party web server coupled by a network to the centralized authentication system, and the login process includes redirection of a user login request from the third-party web server to a server accessing the database and the centralized authentication system.

20. The method as claimed in claim 18, wherein the configuration database includes configuration information for configuring a plurality of applications to the authentication system, the target application transmits a Uniform Resource Locator including an identification of the target application, and the method includes obtaining the identification of the target application from the Uniform Resource Locator, and using the identification of the target application for looking up the configuration information for the target application from the database.

21. The method as claimed in claim 18, which includes obtaining from the database configuration information defining an inbound parameter, and receiving the inbound parameter from the target application.

22. The method as claimed in claim 18, which includes obtaining from the database configuration information defining a natural language, and using the natural language for communication with the user during the login process.

23. The method as claimed in claim 18, wherein the server accessing the database and the centralized authentication system is programmed to obtain from the database configuration information defining an outbound parameter, and the method includes sending the outbound parameter to the target application once the authentication system has authenticated the user.

24. The method as claimed in claim 18, which includes the graphical user interface presenting to the system administrator pages for listing active and inactive target applications integrated with the authentication system, and pages for creating and editing a selected one of the target applications.

25. The method as claimed in claim 18, which includes the graphical user interface presenting to the system administrator pages for selecting a natural language for conducting the login process, for specifying inbound parameters to be received from the target application and outbound parameters to be sent to the target application, for configuring at least one authorization setting, for configuring at least one token, and for selecting an encryption option for encrypting the token.

26. The method as claimed in claim 25, which includes the graphical user interface presenting to the system administrator at least one page for exporting and importing authentication integration projects.

27. A method of using an authentication system for authenticating users of a target application on a first server, the method comprising maintaining a database of configuration information about a login process for the target application, and using a second server to access the database of configuration information to conduct the login process with a user of the target application and to use the authentication system to authenticate the user and to issue at least one token to enable the user to access the target application once the authentication system has authenticated the user, wherein a data network couples the first server to the second server, and the second server receives a Uniform Resource Locator including an identification of the target application and uses the identification of the target application for looking up the configuration information for the login process from the database.

28. The method as claimed in claim 27, wherein the second server obtains from the database configuration information defining an inbound parameter, and the second server receives the inbound parameter from the target application.

29. The method as claimed in claim 27, wherein the second server obtains from the database configuration information defining a natural language, and the second server uses the natural language for communication with the user during the login process.

30. The method as claimed in claim 27, wherein the second server obtains from the database configuration information defining an outbound parameter, and the second server sends the outbound parameter to the target application once the authentication system has authenticated the user.

31. A method of integrating a third-party web application to a centralized authentication system, said method comprising a system administrator using a graphical user interface to select configuration options from a series pages to define the login process to be used when a user logs into the third-party web application, creating an authentication module for the third-party web application, and storing the configuration information in a database, redirecting a user login request from the third-party web application to a server containing the authentication module, and upon receipt of the user login request, the server activating the authentication module to retrieve the configuration information from the database to conduct the login process and to use the authentication system for user authentication and then issuing a token for enabling user access to the third-party web application.
